(19) United States
(12) Patent Application Publication
(10) Pub. No.: US 2009/0299892 A1
(43) Pub. Date: Dec. 3, 2009

(54) TRADE SUPPORT PROCESS SYSTEM, TRADE SUPPORT PROCESS METHOD, AND RECORDING MEDIUM

(76) Inventors: Hiroyuki Kasai, Kanagawa (JP); Eiichi Tezuka, Tokyo (JP); Keisuke Sekiguchi, Kanagawa (JP); Shinya Kimoto, Tokyo (JP); Yumi Yamamoto, Kanagawa (JP); Junko Yoshida, Kanagawa (JP); Yoshikazu Takita, Kanagawa (JP); Seiji Goto, Capelle a/d ljssel (NL); Takashi Kusakari, Saitama (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/476,459

(22) Filed: Jun. 2, 2009

(30) Foreign Application Priority Data
Jun. 3, 2008 (JP) 2008-146184

(51) Int. Cl. G06Q 40/00

(52) U.S. Cl. 705/37

(57) ABSTRACT

Receipt of an order for a support for transportation in a trade or for documentation in a trade is managed. A control unit of a service management server sends an order receipt information registration screen. In a case where a service pattern is selected on the order receipt information registration screen, the control unit retrieves service plans that constitute the service pattern, and outputs the service plans. Then, the control unit acquires order receipt particulars information about the service plans. Then, the control unit registers order receipt management data. On the other hand, in a case where order receipt information is input in the order receipt information registration screen, the control unit retrieves a service plan that matches the order receipt information, and outputs the service plan.

### BACKGROUND OF THE INVENTION

1. Field of the Invention

The present invention relates to a trade support process system, a trade support process method, and a recording medium storing trade support process program.

2. Description of the Related Art

Trades involve many parties and have various patterns according to the parties involved. For example, intermediary trades are carried out among three parties, namely merchants, agents, and buyers. Agents purchase merchandise from merchants and sell the merchandise to buyers. The merchandise is transported to the buyers directly from the merchants.

Imports or exports require a document (invoice) that serves as a letter of transmittal of goods, a description of goods, a price calculation statement, and a billing statement. Especially, intermediary trades described above require an invoice between the merchant and the agent and an invoice between the agent and the buyer.

Unexamined Japanese Patent Application KOKAI Publication No. 2003-157313 discloses a trade procedure system that generates a trading document necessary for exporting a cargo and automatically performs issuance of an air waybill and customs entry of the cargo. Unexamined Japanese Patent Application KOKAI Publication No. 2003-85420 discloses an invoice generating apparatus that efficiently generates invoices for intermediary trades.

### SUMMARY OF THE INVENTION

An object of the present invention is to provide a trade support process system, a trade support process method, and a recording medium storing a trade support process program that manage receipt of an order for a support for transportation in a trade or documentation in a trade.

To achieve the above object, a trade support process system according to a first aspect of the present invention includes: a service plan code storage unit that stores a service plan code in association with a service code and a client code, the service plan code being an identification of a service plan, the service plan being information in which a service regarding a trade procedure and a client to whom the service is provided are associated, the service code being an identification of the service, and the client code being an identification of the client to whom the service is provided; a service pattern data storage unit that stores a service pattern code, which is an identification of a service pattern constituted by a plurality of such service plans as said above, in association with the service plan codes of the service plans that constitute the service pattern; an order receipt management data storage unit that records the client code in association with the service code of the service, which is ordered by the client identified by the client code; a service pattern retrieving unit that, when the service pattern code is acquired from a user terminal, retrieves the service plan codes associated with the acquired service pattern code from the service pattern data storage unit; a service plan setting unit that retrieves the service codes associated with the service plan codes retrieved by the service pattern retrieving unit from the service plan code storage unit, and outputs the retrieved service codes to the user terminal; and an order receipt information registering unit that acquires the service code, which is selected by the user terminal, assigns an order receipt management code to the acquired service code, and records the service code in association with the client code in the order receipt management data storage unit.

The order receipt management data storage unit may record status information in association with the service code, and the trade support process system may further include a status managing unit that, when a completion notification indicating that the service has been provided to the client is acquired from the user terminal, records a completion flag, by which it is identified that the service has been provided, as the status information in the order receipt management data storage unit.

The trade support process system may further include a service information storage unit that stores an amount to charge in association with the service code, and, in a case where the completion flag is recorded for all the service codes that are associated with the order receipt management code and the client code, the status managing unit may permit charging the client having the client code the amount to charge recorded in the service information storage unit.

A trade support process method according to a second aspect of the present invention is a trade support process method that involves use of a trade support process system including: a service plan code storage unit that stores a service plan code in association with a service code and a client code, the service plan code being an identification of a service plan, the service plan being information in which a service regarding a trade procedure and a client to whom the service is provided are associated, the service code being an identification of the service, and the client code being an identification of the client to whom the service is provided; a service pattern data storage unit that stores a service pattern code, which is an identification of a service pattern constituted by a plurality of such service plans as said above, in association with the service plan codes of the service plans that constitute the service pattern; and an order receipt management data storage unit that records the client code in association with the service code of the service, which is ordered by the client identified by the client code, and the method includes: retrieving, when the service pattern code is acquired from a user terminal, the service plan codes associated with the acquired service pattern code from the service pattern data storage unit; retrieving the service codes associated with the retrieved service plan codes from the service plan code storage unit, and outputting the retrieved service codes to the user terminal; and acquiring the service code, which is selected by the user terminal, assigning an order receipt management code to the acquired service code, and recording the service code in association with the client code in the order receipt management data storage unit.

A recording medium according to a third aspect of the present invention stores a trade support process program that controls a computer including: a service plan code storage unit that stores a service plan code in association with a service code and a client code, the service plan code being an identification of a service plan, the service plan being information in which a service regarding a trade procedure and a client to whom the service is provided are associated, the service code being an identification of the service, and the client code being an identification of the client to whom the service is provided; a service pattern data storage unit that stores a service pattern code, which is an identification of a service pattern constituted by a plurality of such service plans as said above, in association with the service plan codes of the service plans that constitute the service pattern; and an order receipt management data storage unit that records the client code in association with the service code of the service, which is ordered by the client identified by the client code, the program controlling the computer to function as: a service pattern retrieving unit that, when the service pattern code is acquired from a user terminal, retrieves the service plan codes associated with the acquired service pattern code from the service pattern data storage unit; a service plan setting unit that retrieves the service codes associated with the service plan codes retrieved by the service pattern retrieving unit from the service plan code storage unit, and outputs the retrieved service codes to the user terminal; and an order receipt information registering unit that acquires the service code, which is selected by the user terminal, assigns an order receipt management code to the acquired service code, and records the service code in association with the client code in the order receipt management data storage unit.

According to the present invention, when the service pattern code is acquired from the user terminal, service plan codes associated with the acquired service pattern code are retrieved from the service pattern data storage unit. Then, service codes associated with the retrieved service plan codes are retrieved from the service plan code data storage unit, and output to the user terminal. Then, a service code selected by the user terminal is acquired, an order receipt management code is assigned to the acquired service code, and the service code is recorded in the order receipt management data storage unit in association with a client code. Accordingly, it is possible to efficiently receive an order for a service for supporting a trade in which a plurality of clients are involved.

According to the present invention, when a completion notification indicating that a service has been provided to a client is acquired from the user terminal, a completion flag by which it is identified that the service has been provided is recorded as status information in the order receipt management data storage unit. Accordingly, it is possible to manage a service providing status.

According to the present invention, in a case where the completion flag is recorded for all the service codes that are associated with an order receipt management code and a client code, it is permitted to charge the client having the client code an amount to charge recorded in a service information storage unit. Accordingly, it is possible to perform appropriate charging.

### BRIEF DESCRIPTION OF THE DRAWINGS

These objects and other objects and advantages of the present invention will become more apparent upon reading of the following detailed description and the accompanying drawings in which:

FIG. 1 is a schematic diagram of a system according to an embodiment of the present invention;

FIG. 2 is an explanatory diagram of data recorded in a service pattern data storage unit;

FIG. 3 is an explanatory diagram of data recorded in a service plan data storage unit;

FIG. 4 is an explanatory diagram of data recorded in a service list data storage unit;

FIG. 5 is an explanatory diagram of data recorded in an order receipt management data storage unit;

FIG. 6 is a flowchart of an order receiving process according to the present embodiment;

FIG. 7 is an explanatory diagram of an order receipt information registration screen output on a user terminal; and

FIG. 8 is an explanatory diagram of trade procedures.

### DETAILED DESCRIPTION OF THE PREFERRED EMBODIMENT

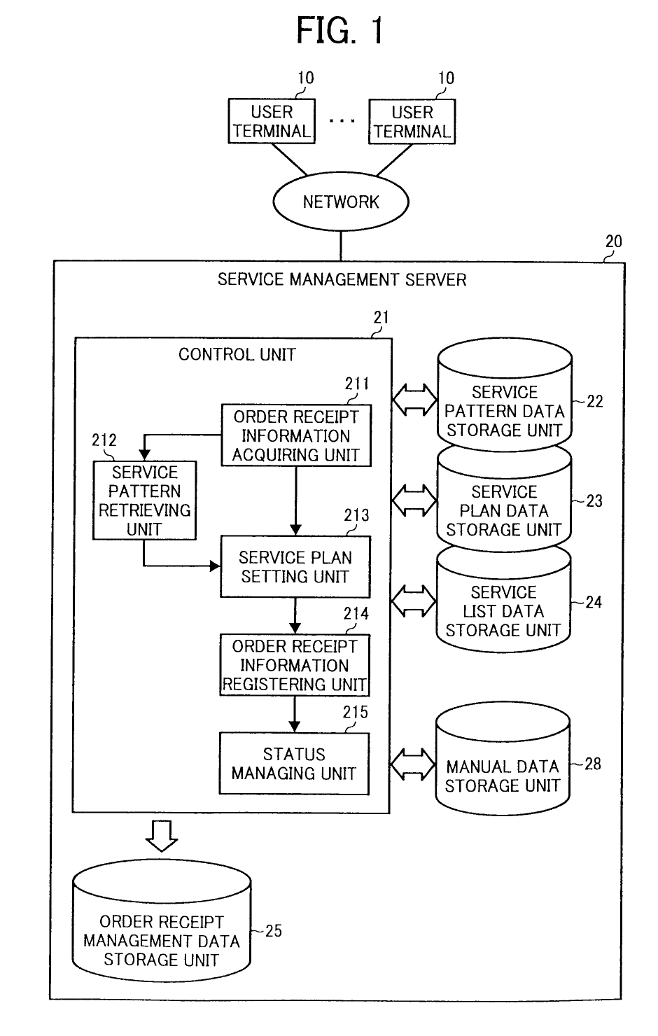

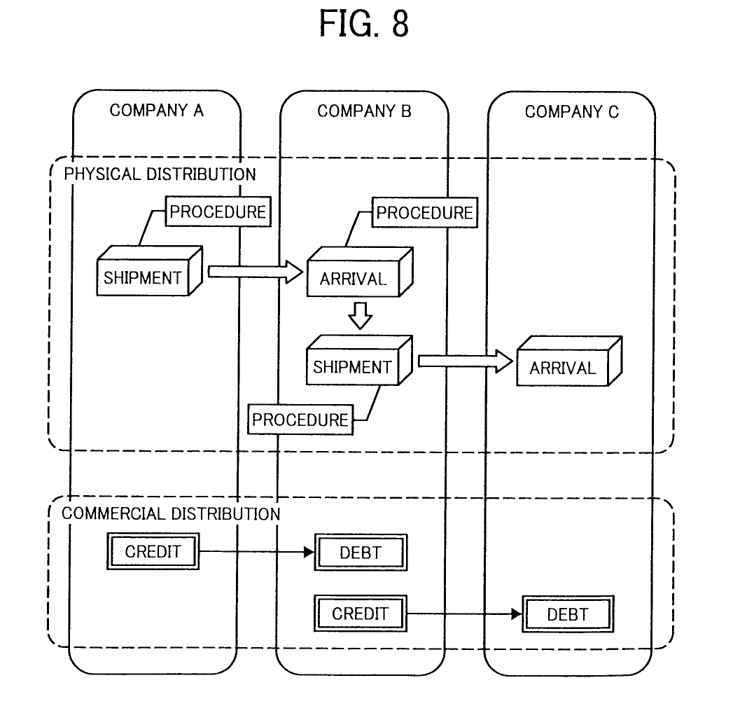

An embodiment of the present invention will be explained below with reference to FIG. 1 to FIG. 8. A trade support process system according to the present invention is a system that manages receipt of an order for a service (trade support service) for supporting transportation in a trade or for supporting documentation in a trade. The present embodiment assumes a case of order receipt management, in which a trade support service is provided to a company A and a company B shown in FIG. 8. A physical distribution from the company A to the company B requires a procedure when the company A ships goods and a procedure when the goods arrive at the company B. Likewise, a physical distribution from the company B to the company C requires a procedure when the company B ships goods. A commercial distribution of a credit and a debt occurs between the company A and the company B, in which procedures are also required. The trade support process system according to the present invention manages receipt of an order for a service (trade support service) for supporting documentation in such procedures in a trade.

As shown in FIG. 1, user terminals 10 and a service management server 20 are connected to each other via a network. The service management server 20 functions as the trade support process system according to the present invention. As shown in FIG. 1, the service management server 20 includes a control unit 21 constituted by a CPU, a RAM, a ROM, etc., a service pattern data storage unit 22, a service plan data storage unit 23, a service list data storage unit 24, an order receipt management data storage unit 25, a manual data storage unit 28, etc.

The control unit 21 performs a process for managing receipt of an order for a support for trade management. By executing a trade support process program read out from a recording medium, the control unit 21 functions as an order receipt information acquiring unit 211, a service pattern retrieving unit 212, a service plan setting unit 213, an order receipt information registering unit 214, and a status managing unit 215.

The order receipt information acquiring unit 211 acquires order receipt information for a trade support service from the user terminal 10.

The service pattern retrieving unit 212 retrieves service plans related to a service pattern that is selected by the user terminal 10.

The service plan setting unit 213 retrieves a service plan associated with a service pattern or order receipt information and helps set order receipt particulars information for a trade support service.

The order receipt information registering unit 214 registers an order receipt management record when order receipt particulars information is set by the user terminal 10.

The status managing unit 215 manages a progress status of a trade support service for which an order was received, and manages a charging process according to the status.

According to the present embodiment, a service plan is a predefined plan for providing a trade support service. A service pattern is a package of a plurality of such service plans. The trade support service will hereinafter be referred to simply as service from time to time.

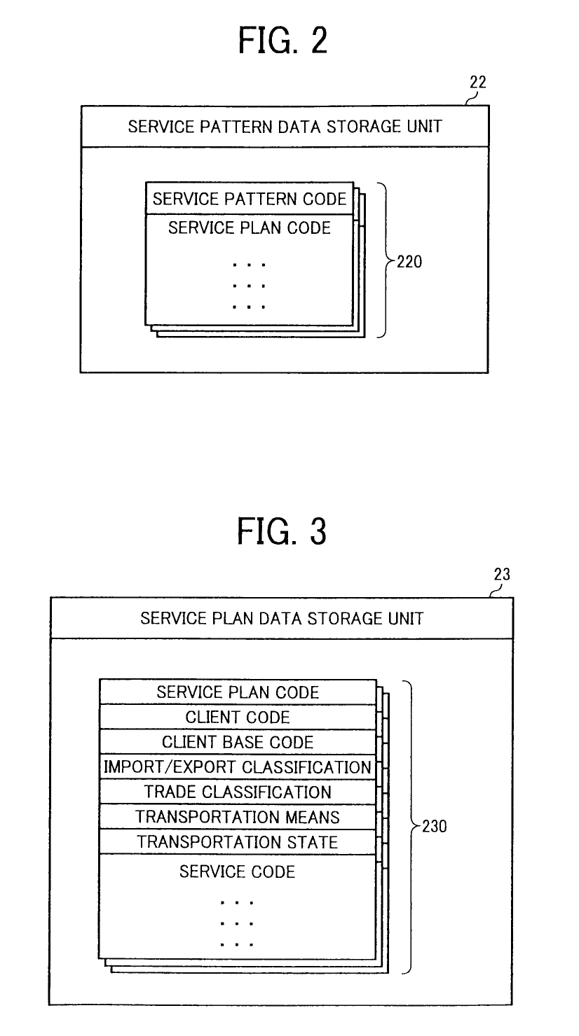

As shown in FIG. 2, the service pattern data storage unit 22 stores a plurality of service pattern records 220 that are associated with service patterns. When a new service pattern is registered, a new service pattern record 220 is recorded in the service pattern data storage unit 22. Each service pattern record 220 is constituted by a service pattern code and service plan codes. The service pattern code is an identifier for identifying each service pattern. The service plan code is an identifier for identifying a service plan included in each service pattern.

As shown in FIG. 3, the service plan data storage unit 23 stores a plurality of service plan records 230 regarding the details of service plans. When a new service plan is registered, a new service plan record 230 is recorded in the service plan data storage unit 23. Each service plan record 230 is constituted by a service plan code, a client code, a client base code, an import/export classification, a trade classification, a transportation means, a transportation state, and at least one service code. The service plan code is an identifier for identifying each service plan. The client code is an identifier for identifying the client to whom the service plan is provided. The client base code is an identifier for identifying the division of the client that uses the service plan. The import/export classification is an identifier for identifying whether the service plan is associated with an “import” service or with an “export” service. The trade classification is an identifier for identifying the trade type. According to the present embodiment, the trade classification identifier specifies “direct trade”, “indirect trade”, “intermediary trade”, etc. The transportation means is an identifier for identifying a means of transporting a cargo. According to the present embodiment, the transportation means identifier specifies “by sea”, “by air”, etc. The transportation state is an identifier for identifying a state in which a cargo is transported. According to the present embodiment, the transportation state identifier specifies a container size, “full container load (FCL)”, “less than l container load (LCL)”, etc. The service code is an identifier for specifying the details of a service to be provided in the service plan. According to the present embodiment, the service code identifier specifies “packaging”, “transportation”, “documentation”, “vicarious performance of a procedure”, “customs clearing”, etc.

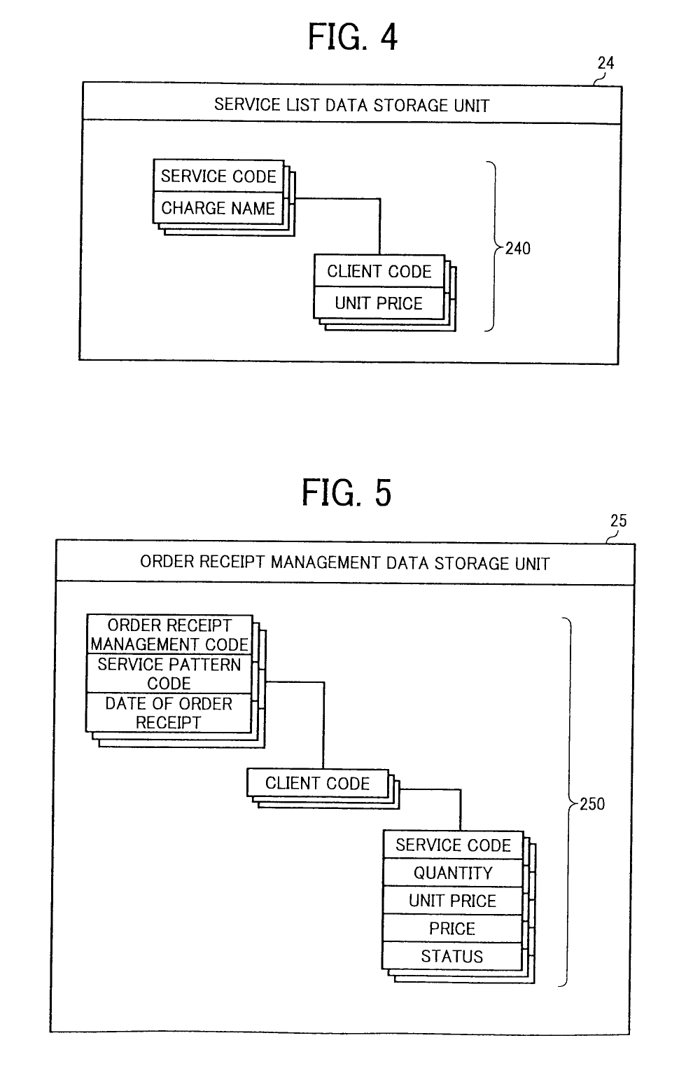

As shown in FIG. 4, the service list data storage unit 24 stores service list records 240 regarding the contents of services. When the user terminal 10 registers a new service, a new service list record 240 is recorded in the service list data storage unit 24. Each service list record 240 is constituted by a service code, a charge name, a client code, and a unit price. The service code is an identifier for identifying a service. The charge name is data regarding a name for when making a charge for the service. The client code is an identifier for identifying the client who receives the service. The unit price is data regarding the price at which the service is provided to the client.

As shown in FIG. 5, the order receipt management data storage unit 25 stores order receipt management records 250 regarding services for which orders were received. When the user terminal 10 registers new order receipt information, a new order receipt management record 250 is registered in the order receipt management data storage unit 25. Each order receipt management record 250 is constituted by an order receipt management code, a service pattern code, and a date of order receipt. The order receipt management code is associated with a client code, a service code, a quantity, a unit price, a price, and a status. The order receipt management code is an identifier for identifying a receipt of an order. The service pattern code is an identifier for identifying a service pattern set in receiving the order. In a case where an order is received not based on a service pattern but based on a service plan, this data field is left blank. The date of order receipt is data about the date on which the order for the service is received. The client code is an identifier for identifying a client to whom the service of the received order is provided. In a case where a plurality of clients are involved in one received order, a plurality of client codes are recorded. The service code is an identifier for identifying a service to be provided to the client. In a case where a plurality of services are to be provided to one client, a plurality of service codes are recorded. The quantity, the unit price, and the price are identifiers for specifying the quantity, the unit price, and the price of the service to be provided to the client. The status is data for specifying a status of providing of the service.

The manual data storage unit 28 stores documentation manuals that prescribe rules for providing services to clients. A documentation manual is set for each client code. Further, a documentation manual is set for each of credit/debt classification, import/export classification, trade classification, and transportation state. The documentation manual includes manuals that prescribe name, place, term, case mark, document addressee, etc. The manuals for name, place, and term are looked up in generating an invoice.

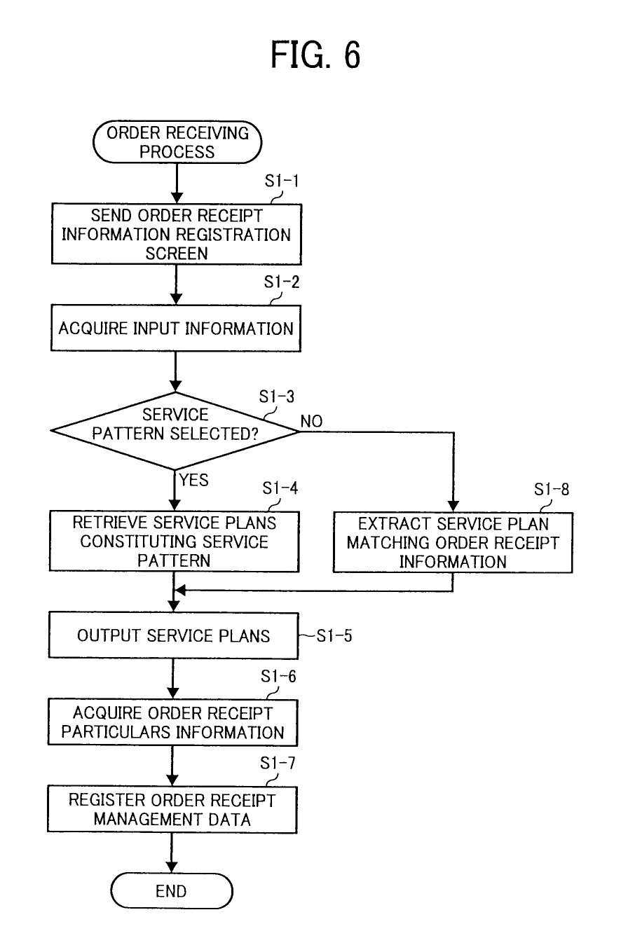

Next, a procedure for managing receipt of an order for a trade support service for documentation by using the system having the above-described configuration will be explained with reference to FIG. 6.

(Order Receiving Process)

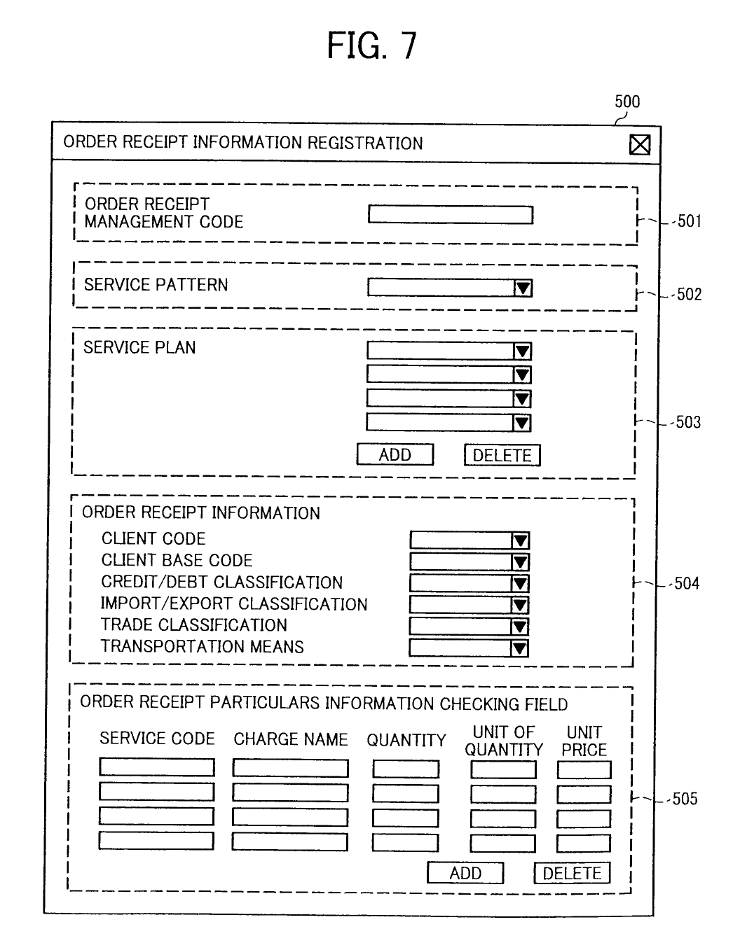

First, the control unit 21 sends order receipt information registration screen data (step S1-1). When using a service, a user accesses the service management server 20 by using the user terminal 10. In response to this access, the order receipt information acquiring unit 211 of the control unit 21 sends the order receipt information registration screen data to the user terminal 10. An order receipt information registration screen 500 shown in FIG. 7 is output on the display of the user terminal 10 that has received this data.

The order receipt information registration screen 500 includes an order receipt management code display area 501, a service pattern setting area 502, a service plan setting area 503, an order receipt information setting area 504, and an order receipt particulars information checking field 505. A code that is automatically assigned by the service management server 20 is set in the order receipt management code area 501. A setting field to set a service pattern is allocated in the service pattern setting area 502. When a service pattern code is selected at the setting field of the service pattern setting area 502, the user terminal 10 sends input information that includes the selected service pattern code to the service management server 20. Setting fields to set service plans are allocated in the service plan setting area 503. Setting fields to input order receipt information separately are allocated in the order receipt information setting area 504. When information is input to each setting field of the order receipt information setting area 504, the user terminal 10 sends input information that includes the input order information to the service management server 20. Setting fields to input details information about each service plan are allocated in the order receipt particulars information checking field 505. The contents of each service included in a service plan are displayed as default values in the setting fields of the order receipt particulars information checking field 505. The quantity of each service to be provided to the client can be set in the setting fields of the order receipt particulars information checking field 505. The user terminal 10 sends input information that includes information input to the setting fields of the order receipt particulars information checking field 505 to the service management server 20.

Next, the control unit 21 acquires the input information from the user terminal 10 (step S1-2). Specifically, the order receipt information acquiring unit 211 of the control unit 21 receives the input information that includes a service pattern code, order receipt information, or the like from the user terminal 10.

Then, the control unit 21 determines whether a service pattern has been selected or order receipt information has been selected (step S1-3). Specifically, the order receipt information acquiring unit 211 of the control unit 21 determines whether a service pattern has been selected or order receipt information has been selected based on whether the input information acquired from the user terminal 10 includes a service pattern code or order receipt information.

In a case where it is determined that a service pattern has been selected (step S1-3; YES), the control unit 21 retrieves service plans that constitute the service pattern (step S1-4). Specifically, the service pattern retrieving unit 212 of the control unit 21 retrieves service plan codes stored in association with the service pattern from the service pattern data storage unit 22.

Next, the control unit 21 outputs the service plans (step S1-5). Specifically, the service plan setting unit 213 of the control unit 21 extracts the service plan records 230 about the service plans retrieved by the service pattern retrieving unit 212 from the service plan data storage unit 23. Then, service details information recorded in the extracted service plan records 230 is sent to the user terminal 10. The user terminal 10 stores the received service details information in a memory, and displays the corresponding service plan codes in the service plan setting area 503 of the order receipt information registration screen 500. When a service plan is selected in the service plan setting area 503, the user terminal 10 outputs the service details information corresponding to the selected service plan in the order receipt particulars information checking field 505.

Next, the control unit 21 acquires order receipt particulars information (step S1-6). Specifically, the user makes necessary addition, deletion, or correction to the service plans displayed in the service plan setting area 503 and to the order receipt particulars information displayed in the order receipt particulars information checking field 505 of the order receipt information registration screen 500. When the user completes setting the order particulars information, the user inputs a registration instruction to the user terminal 10. In response to this, the user terminal 10 sends the order receipt particulars information to the service management server 20. Then, the order receipt information registering unit 214 of the control unit 21 receives the order receipt particulars information from the user terminal 10.

Then, the control unit 21 registers order receipt management data (step S1-7). Specifically, the order receipt information registering unit 214 of the control unit 21 generates an order receipt management record 250 that includes the received order receipt particulars information, and registers the generated record in the order receipt management data storage unit 25. In this case, the order receipt information registering unit 214 leaves the status set for each service code blank.

In contrast, in a case where it is determined based on the input information that order receipt information has been selected (step S1-3; NO), the control unit 21 extracts a service plan that matches the order receipt information (step S1-8). Specifically, the service plan setting unit 213 of the control unit 21 extracts a service plan record 230 that matches the received order receipt information from the service plan data storage unit 23.

Then, the control unit 21 outputs the service plan (step S1-5). Specifically, the service plan setting unit 213 of the control unit 21 sends service details information recorded in the extracted service plan record 230 to the user terminal 10.

(Service Providing Process)

When a user provides a service to a client, the user first accesses the service management server 20 by using the user terminal 10, sets the client code, and requests a document. In response to this, the user terminal 10 sends a document request to the service management server 20. This document request includes the client code.

In response to the document request, the control unit 21 retrieves the documentation manual associated with the received client code from the manual data storage unit 28 and outputs the manual to the user terminal 10. The user can provide the documentation service, etc. to the client by looking up this documentation manual. Hence, it is possible to support a trade based on the rules set for each client.

(Status Managing Process)

When a user has completed providing a service to a client, the user accesses the service management server 20 by using the user terminal 10, and inputs the status of the service. Specifically, the user sets an order receipt management code and a client code in the user terminal 10, and inputs information that the service provision has been completed for the corresponding service code. In response to this, the user terminal 10 sends a completion notification to the service management server 20. This completion notification includes the order receipt management code, the client code, and the service code.

In response to the completion notification, the control unit 21 performs a status registering process. Specifically, the status managing unit 215 of the control unit 21 extracts an order receipt management record 250 that includes the received order receipt management code and client code, from the order receipt management data storage unit 25, and records a completion flag in the data area of the status corresponding to the service code.

Next, when the user charges the client, the user accesses the service management server 20 by using the user terminal 10 and inputs a request for making a charge for the service. Specifically, the user specifies the order receipt management code and the client code in the user terminal 10 and inputs a request for making a charge. In response to this input, the user terminal 10 sends a charge instruction to the service management server 20. This charge instruction includes the order receipt management code and the client code.

In response to the charge instruction, the control unit 21 performs a charging process. Specifically, the status managing unit 215 of the control unit 21 extracts an order receipt management record 250 that includes the received order receipt management code and client code, from the order receipt management data storage unit 25. In a case where the completion flag is recorded for all the service codes associated with the client code in the extracted order receipt management record 250, the status managing unit 215 permits charging the company having this client code, and issues a billing statement. Specifically, the status managing unit 215 calculates the amount to charge for each service by multiplying the unit price and the quantity recorded in the order receipt management record 250 and generates a billing statement. Then, the status managing unit 215 performs a process for sending the billing statement to the client. The status managing unit 215 records a charge completion flag in the data area of the status.

As can be understood from the above, according to the present embodiment, it is possible to achieve the following effects.

In the embodiment described above, the service pattern data storage unit 22 stores the service pattern records 220 regarding the packages (service patterns) of service plans for supporting trades from shipment to final arrival. Each service pattern record 220 is constituted by a service pattern code and service plan codes. When a service pattern is selected (step S1-3; YES), the control unit 21 retrieves the service plans that constitute the service pattern (step S1-4). This makes it possible to set the service plans that are to be provided to each client according to the service pattern that specifies a trade type.

In the embodiment described above, the service plan data storage unit 23 stores the service plan records 230 regarding the combinations (service plans) of services that may be provided to companies that run import/export businesses. Each service plan record 230 is constituted by a service plan code, a client code, a client base code, an import/export classification, a trade classification, a transportation means, a transportation state, and a service code. When a service plan is set at step S1-5 or at step S1-8, the control unit 21 performs a process for finalizing order receipt particulars information (step S1-6). This makes it possible to specify necessary services when a service plan is set.

In the embodiment described above, the service list data storage unit 24 stores the service list records 240 regarding the contents of the services. Each service list record 240 is constituted by a service code, a charge name, a client code, and a unit price. This makes it possible to calculate a fee by specifying a unit price, once a necessary service is specified.

In the embodiment described above, the order receipt management data storage unit 25 stores the order receipt management records 250 regarding services for which orders were received. Each order receipt management record 250 is constituted by an order receipt management code, a service pattern code, a client code, a service code, and a status. By using this status, it is possible to know a service providing status and make a charge.

The embodiment described above may be modified to the following modes.

In the embodiment described above, in charging a client, the service management server 20 is accessed by the user terminal 10 and a request for making a charge for a service is input. Instead of this, the control unit 21 may perform a charging process regularly. Specifically, the status managing unit 215 of the control unit 21 checks the status recorded in the order receipt management records 250 regularly. When the status managing unit 215 detects an order receipt management record 250 in which a completion flag is recorded for all the service codes associated with a client code, the status managing unit 215 permits charging the company having this client code and issues a billing statement. This enables efficient charging.

In the embodiment described above, the service pattern data storage unit 22 stores the service pattern records 220 regarding the packages (service patterns) of service plans for supporting trades from shipment to final arrival. Here, the control unit 21 may automatically generate a service pattern record 220. Specifically, when a plurality of service plans are set in the order receipt information registration screen 500, the control unit 21 searches the service pattern data storage unit 22 for any service pattern record 220 in which these service plans are packaged. In a case where no such service pattern record 220 can be extracted, the control unit 21 generates a service pattern record 220 that includes these service plans and registers the record in the service pattern data storage unit 22.

In the embodiment described above, a user sets a service pattern or order receipt information in the order receipt information registration screen 500. When a service plan is set in the order receipt information registration screen 500, a service pattern that includes this service plan may be output as a selection candidate. Specifically, the control unit 21 searches the service pattern data storage unit 22 for a service pattern record 220 that includes the set service plan. In a case where such a service pattern record 220 is extracted, the control unit 21 outputs the record to the user terminal 10 as a service pattern candidate. This enables an efficient order receiving process.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2008-146184 filed on Jun. 3, 2008 and including specification, claims, drawings and summary. The disclosure of the above Japanese Patent Application is incorporated herein by reference in its entirety.

What is claimed is:

1. A trade support process system, comprising:
a service plan code storage unit that stores a service plan code in association with a service code and a client code, the service plan code being an identification of a service plan, the service plan being information in which a service regarding a trade procedure and a client to whom the service is provided are associated, the service code being an identification of the service, and the client code being an identification of the client to whom the service is provided;
a service pattern data storage unit that stores a service pattern code, which is an identification of a service pattern constituted by a plurality of such service plans as said above, in association with the service plan codes of the service plans that constitute the service pattern;
an order receipt management data storage unit that records the client code in association with the service code of the service, which is ordered by the client identified by the client code;
a service pattern retrieving unit that, when the service pattern code is acquired from a user terminal, retrieves the service plan codes associated with the acquired service pattern code from the service pattern data storage unit;
a service plan setting unit that retrieves the service codes associated with the service plan codes retrieved by the service pattern retrieving unit from the service plan code storage unit, and outputs the retrieved service codes to the user terminal; and
an order receipt information registering unit that acquires the service code, which is selected by the user terminal, assigns an order receipt management code to the acquired service code, and records the service code in association with the client code in the order receipt management data storage unit.

2. The trade support process system according to claim 1,
wherein the order receipt management data storage unit records status information in association with the service code, and
the trade support process system further comprises a status managing unit that, when a completion notification indicating that the service has been provided to the client is acquired from the user terminal, records a completion flag, by which it is identified that the service has been provided, as the status information in the order receipt management data storage unit.

3. The trade support process system according to claim 2, further comprising a service information storage unit that stores an amount to charge in association with the service code,
wherein in a case where the completion flag is recorded for all the service codes that are associated with the order receipt management code and the client code, the status managing unit permits charging the client having the client code the amount to charge recorded in the service information storage unit.

4. A trade support process method, involving use of a trade support process system including:
a service plan code storage unit that stores a service plan code in association with a service code and a client code, the service plan code being an identification of a service plan, the service plan being information in which a service regarding a trade procedure and a client to whom the service is provided are associated, the service code being an identification of the service, and the client code being an identification of the client to whom the service is provided;
a service pattern data storage unit that stores a service pattern code, which is an identification of a service pattern constituted by a plurality of such service plans as said above, in association with the service plan codes of the service plans that constitute the service pattern; and
an order receipt management data storage unit that records the client code in association with the service code of the service, which is ordered by the client identified by the client code,
the method comprising:
when the service pattern code is acquired from a user terminal, retrieving the service plan codes associated with the acquired service pattern code from the service pattern data storage unit;
retrieving the service codes associated with the retrieved service plan codes from the service plan code storage unit, and outputting the retrieved service codes to the user terminal; and
acquiring the service code, which is selected by the user terminal, assigning an order receipt management code to the acquired service code, and recording the service code in association with the client code in the order receipt management data storage unit.

5. A recording medium storing a trade support process program that controls a computer including:
a service plan code storage unit that stores a service plan code in association with a service code and a client code, the service plan code being an identification of a service plan, the service plan being information in which a service regarding a trade procedure and a client to whom the service is provided are associated, the service code being an identification of the service, and the client code being an identification of the client to whom the service is provided;
a service pattern data storage unit that stores a service pattern code, which is an identification of a service pattern constituted by a plurality of such service plans as said above, in association with the service plan codes of the service plans that constitute the service pattern; and
an order receipt management data storage unit that records the client code in association with the service code of the service, which is ordered by the client identified by the client code,
the program controlling the computer to function as:
a service pattern retrieving unit that, when the service pattern code is acquired from a user terminal, retrieves the service plan codes associated with the acquired service pattern code from the service pattern data storage unit;
a service plan setting unit that retrieves the service codes associated with the service plan codes retrieved by the service pattern retrieving unit from the service plan code storage unit, and outputs the retrieved service codes to the user terminal; and
an order receipt information registering unit that acquires the service code, which is selected by the user terminal, assigns an order receipt management code to the acquired service code, and records the service code in association with the client code in the order receipt management data storage unit.
